(19) United States
(12) Patent Application Publication
(10) Pub. No.: US 2024/0275552 A1
(43) Pub. Date: Aug. 15, 2024

(54) POSITIONING BANDWIDTH AGGREGATION OF POSITIONING REFERENCE SIGNAL (PRS) AND SOUNDING REFERENCE SIGNAL (SRS)

(71) Applicant: Intel Corporation, Santa Clara, CA (US)

(72) Inventors: Gang Xiong, Portland, OR (US); Debdeep Chatterjee, San Jose, CA (US)

(21) Appl. No.: 18/642,455

(22) Filed: Apr. 22, 2024

Related U.S. Application Data
(60) Provisional application No. 63/501,245, filed on May 10, 2023.

(51) Int. Cl. H04L 5/00; H04W 76/20; H04W 76/30

(52) U.S. Cl. CPC H04L 5/0051; H04L 5/001; H04W 76/20; H04W 76/30

(57) ABSTRACT

Various embodiments herein provide techniques related to configuration that may be provided to a user equipment (UE). The configuration information may include: a resource configuration that indicates that the UE is to transmit a first reference signal (RS) on a first component carrier of a plurality of component carriers, wherein the first RS is an RS of a first RS set; and a resource configuration that indicates that the UE is to transmit a second RS on a second component carrier of the plurality of component carriers, wherein the second RS is an RS of a second RS set, wherein the first RS resource set and the second RS resource set are linked for bandwidth aggregation. Other embodiments may be described and/or claimed.

### CROSS REFERENCE TO RELATED APPLICATION

The present application claims priority to U.S. Provisional Patent Application No. 63/501,245, which was filed May 10, 2023, the disclosure of which IS hereby incorporated by reference.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 depicts an example of bandwidth aggregation for sounding reference signal (SRS) transmission across intra-band contiguous carriers, in accordance with various embodiments.

FIG. 2 depicts an example of transmit power determination for positioning sounding reference signal(s) with bandwidth aggregation, in accordance with various embodiments.

FIG. 3 schematically illustrates a wireless network in accordance with various embodiments.

FIG. 4 schematically illustrates components of a wireless network in accordance with various embodiments.

FIG. 5 is a block diagram illustrating components, according to some example embodiments, able to read instructions from a machine-readable or computer-readable medium (e.g., a non-transitory machine-readable storage medium) and perform any one or more of the methodologies discussed herein.

FIG. 6 illustrates a network in accordance with various embodiments.

FIG. 7 depicts an example procedure for practicing the various embodiments discussed herein.

FIG. 8 depicts another example procedure for practicing the various embodiments discussed herein.

FIG. 9 depicts another example procedure for practicing the various embodiments discussed herein.

FIG. 10 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has evolved significantly from early voice systems to today's highly sophisticated integrated communication platform. The next generation wireless communication system, which may be referred to as a fifth generation (5G) system and/or a new radio (NR) system, may provide access to information and sharing of data anywhere, anytime by various users and applications. NR may serve as a unified network/system that is targeted to meet vastly different and sometime conflicting performance dimensions and services. Such diverse multi-dimensional requirements may be driven by different services and applications. In general, NR may be expected to evolve based on third generation partnership project (3GPP) LTE-Advanced (LTE-A) with additional potential new Radio Access Technologies (RATs) to enrich people lives with better, simple, and seamless wireless connectivity solutions. NR may enable connection by wireless and deliver fast, rich contents and services.

Generally, NR may support highly precise positioning in the vertical and horizontal dimensions, which relies on timing-based, angle-based, power-based, and/or hybrid techniques to estimate the user location in the network. In particular, the following example RAT-dependent positioning techniques may be used. The various RAT-dependent positioning techniques may be able to meet the positioning requirements for various use cases, e.g., indoor, outdoor, Industrial internet of thing (IoT), etc. The RAT-dependent positioning techniques may be or relate to one or more of the following:
Downlink time difference of arrival (DL-TDOA)
Uplink time difference of arrival (UL-TDOA)
Downlink angle of departure (DL-AoD)
Uplink angle of arrival (UL AoA)
Multi-cell round trip time (multi-RTT)
NR enhanced cell ID (E-CID)

With wide bandwidth for positioning signal and beamforming capability in the millimeter wave (mmWave) frequency band, higher positioning accuracy may be achieved by RAT dependent positioning techniques. Specifically, the higher positioning accuracy may be achieved by those techniques that employ or relate to time of arrival estimation of received signals. It may be noted that, in the third generation partnership project (3GPP) release 16 (Rel-16) specifications, downlink positioning reference signal (DL-PRS) and uplink sounding reference signal (UL-SRS) for positioning were introduced as possible enablers to achieve target performance characteristics.

To further improve the positioning accuracy, bandwidth aggregation for transmission of DL-PRS and UL-SRS for intra-band contiguous carriers can be considered for single chain transmit/receive (Tx/Rx) architectures at the user equipment (UE) and/or a base station (e.g., the gNodeB or the “gNB”). In this case, multiple channel observations obtained in different carriers may be processed at the receiver side to form a wideband channel realization, which may result in a sample time duration reduction and a discrete Fourier size extension.

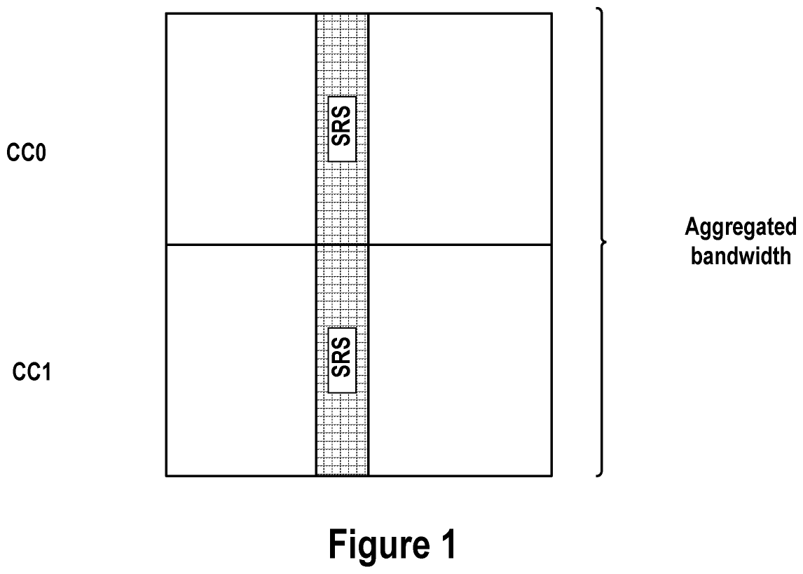

FIG. 1 illustrates one example of bandwidth aggregation for sounding reference signal (SRS) transmission across intra-band contiguous carriers. In the example, an SRS may be simultaneously transmitted across two intra-band contiguous carriers to form a wide band for SRS transmission. In this case, a wideband channel is effectively realized based on multiple channel observations to enhance the time resolution of the DL-TDOA, UL-TDOA, and/or Multi-RTT positioning methods.

For aperiodic SRS transmission for positioning with bandwidth aggregation, a single downlink control information (DCI) may be used to trigger the SRS transmission for positioning in contiguous carriers. In this use case, it may be desirable to enhance one or more signalling mechanisms for triggering of SRS transmission in contiguous carriers.

Embodiments herein relate to positioning bandwidth aggregation of positioning reference signal (PRS) and SRS. In particular, embodiments may include or relate to one or more of the following:
Triggering mechanism for positioning SRS with bandwidth aggregation
Transmit power calculation for positioning SRS transmission with bandwidth aggregation
Measurement report for PRS and positioning SRS with bandwidth aggregation
   Triggering Mechanism for Positioning SRS with Bandwidth Aggregation

As mentioned above, to further improve the positioning accuracy, bandwidth aggregation for transmission of DL-PRS and UL-SRS for intra-band contiguous carriers can be considered for single chain Tx/Rx architectures at both the UE and the base station. In this case, multiple channel observations obtained in different carriers can be processed at the receiver side to form a wideband channel realization, which would result in a sample time duration reduction and an extension to the discrete Fourier size.

For aperiodic SRS transmission for positioning with bandwidth aggregation, a single downlink control information (DCI) may be used to trigger the SRS transmission for positioning in contiguous carriers. In this case, one or more signalling mechanisms may be enhanced to accommodate the triggering of SRS transmission in contiguous carriers.

In the discussion of the following embodiments, “positioning SRS” and “SRS for positioning” may be used interchangeably.

Embodiments of triggering mechanism for positioning SRS with bandwidth aggregation are provided as follows:

In one embodiment, one field may be included in the DCI format 0_1, 0_2, 1_1, and 1_2 to indicate one or more positioning SRS resource sets from one or more contiguous carriers for positioning SRS transmission with bandwidth aggregation.

In one option, a positioning SRS request table may be configured by higher layers via radio resource control (RRC) signalling, where each entry of the table may include a SRS request index for an active BWP for each cell in a set of cells for positioning SRS with bandwidth aggregation. In some aspects, this option may be applied for the use case wherein the carriers for positioning SRS with bandwidth aggregation include configuration of the physical uplink control channel (PUCCH) and/or physical uplink shared channel (PUSCH).

In another option, when the carriers for positioning SRS with bandwidth aggregation are different from the carriers for data communication, and if the carriers for positioning SRS with bandwidth aggregation are configured without PUCCH and/or PUSCH transmission, a positioning SRS request table may be configured by higher layers via RRC signalling, where each entry of the table may include SRS request index for each cell in a set of cells for positioning SRS with bandwidth aggregation.

For one or more of the above options, the field in the DCI may be used to indicate one entry from the SRS request table. The size of the DCI field for request of positioning SRS with bandwidth aggregation may be given by ceiling(log 2(N)), where N is the number of entries in the positioning SRS request table.

In addition, the set of cells that can be used for positioning SRS transmission with bandwidth aggregation can be configured by higher layers via RRC signalling. In this case, ‘SRS request’ indexes for all the configured cells are placed according to an ascending order of a serving cell index, wherein the value of ‘SRS request’ index may be determined based on the DCI format 0_1 or 1_1. In some aspects, when SRS request index with ‘00’ for a cell is included in one entry of the positioning SRS request table, this indicates that no aperiodic SRS transmission is triggered in the cell.

In some aspects, based on the configuration of the table, one entry of the positioning SRS request table may include the triggering of only one SRS resource set in a cell. This may enable dynamic switching between positioning SRS transmission with and without bandwidth aggregation.

Table 1 illustrates one example of a positioning SRS request field for SRS with bandwidth aggregation. In the example, 3 cells {cell ID #0, #1, #2} are configured for positioning SRS transmission with bandwidth aggregation. In addition, 4 entries are configured for the positioning SRS request table, where each entry includes a SRS request index for each configured cell. For instance, when Positioning SRS request field=‘1’, SRS request field with ‘01’ is applied for all three configured cells. This indicates that SRS resource sets configured by SRS-PosResourceSet with an entry in aperiodicSRS-ResourceTriggerList set to 1 are triggered for all three cells.

TABLE 1
Positioning SRS request field for SRS
with bandwidth aggregation: Option 1

| Posi- | |
|---|---|
| tioning | |
| SRS | |
| request | Triggered aperiodic SRS resource set for positioning with |
| field | bandwidth aggregation |
| 0 | SRS request field = ‘00’ for cell ID = 0; SRS request field = |
| | ‘01’ for cell ID = 1; SRS request field = ‘01’ for cell ID = 2 |
| 1 | SRS request field = ‘01’ for cell ID = 0; SRS request field = |
| | ‘01’ for cell ID = 1; SRS request field = ‘01’ for cell ID = 2 |
| 2 | SRS request field = ‘02’ for cell ID = 0; SRS request field = |
| | ‘02’ for cell ID = 1; SRS request field = ‘02’ for cell ID = 2 |
| 3 | SRS request field = ‘01’ for cell ID = 0; SRS request field = |
| | ‘01’ for cell ID = 1; SRS request field = ‘00’ for cell ID = 2 |

As a further extension, in order to ensure backward compatibility, SRS request field in the DCI format 0_1, 0_2 1_1, and/or 1_2 may be extended to include additional rows for a positioning SRS with bandwidth aggregation.

Table 2 illustrates an example of a positioning SRS request field for SRS with bandwidth aggregation. In the example of Table 2, the first four rows in the SRS request field may be similar to the legacy table for SRS request as may be seen in the 3GPP technical specification (TS) 38.212. The remaining four rows may be used for triggering of aperiodic positioning SRS transmission with bandwidth aggregation.

TABLE 2
Positioning SRS request field for SRS
with bandwidth aggregation: Option 2

| SRS | Triggered aperiodic SRS resource set(s) for DCI format |
|---|---|
| request | 0_1, 0_2, 1_1, 1_2, and 2_3 configured with higher layer |
| field | parameter srs-TPC-PDCCH-Group set to ‘typeB’ |
| 0 | No aperiodic SRS resource set triggered |
| 1 | SRS resource set(s) configured by SRS-ResourceSet with |
| | higher layer parameter aperiodicSRS-ResourceTrigger set to |
| | 1 or an entry in aperiodicSRS-ResourceTriggerList set to 1 |
| | SRS resource set(s) configured by SRS-PosResourceSet with |
| | an entry in aperiodicSRS-ResourceTriggerList set to 1 when |
| | triggered by DCI formats 0_1, 0_2, 1_1, and 1_2 |
| 2 | SRS resource set(s) configured by SRS-ResourceSet with |
| | higher layer parameter aperiodicSRS-ResourceTrigger set to |
| | 2 or an entry in aperiodicSRS-ResourceTriggerList set to 2 |
| | SRS resource set(s) configured by SRS-PosResourceSet with |
| | an entry in aperiodicSRS-ResourceTriggerList set to 2 when |
| | triggered by DCI formats 0_1, 0_2, 1_1, and 1_2 |
| 3 | SRS resource set(s) configured by SRS-ResourceSet with |
| | higher layer parameter aperiodicSRS-ResourceTrigger set to |
| | 3 or an entry in aperiodicSRS-ResourceTriggerList set to 3 |
| | SRS resource set(s) configured by SRS-PosResourceSet with |
| | an entry in aperiodicSRS-ResourceTriggerList set to 3 when |
| | triggered by DCI formats 0_1, 0_2, 1_1, and 1_2 |
| 4 | SRS request field = ‘00’ for cell ID = 0; SRS request field = |
| | ‘01’ for cell ID = 1; SRS request field = ‘01’ for cell ID = 2 |
| 5 | SRS request field = ‘01’ for cell ID = 0; SRS request field = |
| | ‘01’ for cell ID = 1; SRS request field = ‘01’ for cell ID = 2 |
| 6 | SRS request field = ‘02’ for cell ID = 0; SRS request field = |
| | ‘02’ for cell ID = 1; SRS request field = ‘02’ for cell ID = 2 |
| 7 | SRS request field = ‘01’ for cell ID = 0; SRS request field = |
| | ‘01’ for cell ID = 1; SRS request field = ‘00’ for cell ID = 2 |

In another option, in the above tables, SRS request field for each cell may point to an SRS resource set configured by SRS-PosResourceSet with an entry in aperiodicSRS-ResourceTriggerList for bandwidth aggregation is set to a value when triggered by DCI formats 0_1, 0_2, 1_1, and 1_2.

In an embodiment, one field may be included in the DCI format 0_1, 0_2, 1_1, and 1_2 to indicate one or more positioning SRS resource sets from one or more contiguous carriers for positioning SRS transmission with bandwidth aggregation.

In particular, one or more groups of positioning SRS resource sets and associated carriers or bandwidth parts (BWPs) may be configured by higher layers via radio resource control (RRC) signalling. In this case, the field for positioning SRS request may point to one group of positioning SRS resource sets and associated carriers or BWPs for SRS transmission with bandwidth aggregation.

In an embodiment, for user equipments (UEs) in RRC_INACTIVE mode, the UEs may be configured or indicated with an initial UL BWP in one carrier while configured with SRS for positioning with bandwidth aggregation in different carriers. In addition, positioning SRS resource sets and associated SRS resources across intra-band contiguous carriers may be configured in an RRC release message for UE in RRC_INACTIVE state.

In one example, an initial UL BWP may be configured in component carrier (CC) #0 and positioning SRS with bandwidth aggregation may be configured in CC #1 and CC #2.

In an embodiment, a bitmap may be configured to indicate whether one or more PRS resource(s) within a linked PRS resource set is linked to one or more other PRS resource set(s) in different carriers. In particular, the size of the bitmap may be determined based on the number of PRS resources within a linked PRS resource set, where bit “1” may be used to indicate that the PRS resource is linked across different carriers while bit “0” may be used to indicate that the PRS resource is not linked across different carriers. As used herein, the term “linked” may refer to a configuration wherein resources of two or more resource sets (e.g., PRS resources of PRS resource sets or SRS resources of SRS resource sets) may be used for bandwidth aggregation as described above.

Further, the UE may determine the linked PRS resource(s) based on the bitmap. In one option, a same bitmap may be applied for a number of mutually linked PRS resource sets. In this case, the UE may determine that the PRS resources in the linked PRS resource sets are linked if the bit “1” is indicated for the PRS resource corresponding to the same positions within the bitmap.

In another option, different bitmaps may be applied for a number of mutually linked PRS resource sets. In this case, the UE may determine that the PRS resources in the linked PRS resource sets are linked if all PRS resources in the same symbol are indicated with bit “1”.

In one example, bitmap “0011” can be configured in two linked PRS resource sets, each with four PRS resources. In this case, PRS resource #0 and #1 in a first and second PRS resource set are not linked, while PRS resource #2 and #3 in a first and second PRS resource set are linked for PRS bandwidth aggregation.

In an embodiment, a bitmap may be configured to indicate whether one or more SRS resource(s) within a linked SRS resource set is/are linked to one or more other SRS resource set(s) in different carriers. In particular, the size of the bitmap may be determined based on the number of SRS resources within a linked SRS resource set, where bit “1” may be used to indicate that the SRS resource is linked across different carriers while bit “0” may be used to indicate that the SRS resource is not linked across different carriers.

Further, a UE may determine the linked SRS resource(s) based on the bitmap. In one option, same bitmap is applied for a number of mutually linked SRS resource sets. In this case, UE may determine that the SRS resources in the linked SRS resource sets are linked if the bit “1” is indicated for the SRS resource corresponding to the same positions within the bitmap.

In another option, different bitmap may be applied for the linked SRS resource set. In this case, UE may determine that the SRS resources in the linked SRS resource sets are linked if all SRS resources in the same symbol are indicated with bit “1”.

In one example, bitmap “0011” can be configured in two linked SRS resource sets, each with four PRS resources. In this case, SRS resource #0 and #1 in a first and second SRS resource set are not linked while SRS resource #2 and #3 in a first and second SRS resource set are linked for SRS bandwidth aggregation.

In an embodiment, for periodic positioning SRS with bandwidth aggregation, when the linkage is SRS resource level, and when more than one SRS resource sets are configured, only the linked SRS resources within the one or more SRS resources may be configured for positioning SRS transmission with bandwidth aggregation. In addition, UE does not transmit positioning SRS that are not linked for SRS with bandwidth aggregation.

For semi-persistent positioning SRS with bandwidth aggregation, when the linkage is SRS resource level, and when more than one SRS resource sets are activated, only the linked SRS resources within the one or more SRS resources are activated for positioning SRS transmission with bandwidth aggregation. In addition, the UE may not transmit positioning SRS that are not linked for SRS with bandwidth aggregation.

For aperiodic positioning SRS with bandwidth aggregation, when the linkage is SRS resource level, and when more than one SRS resource sets are triggered, only the linked SRS resources within the one or more SRS resources are triggered for positioning SRS transmission with bandwidth aggregation. In addition, UE does not transmit positioning SRS that are not linked for SRS with bandwidth aggregation.

In an embodiment, for periodic positioning SRS with bandwidth aggregation, when the linkage is SRS resource level, and when more than one SRS resource sets are configured, all the SRS resources within the one or more SRS resources are configured for positioning SRS transmission with bandwidth aggregation. In addition, UE only needs to enable SRS bandwidth aggregation for positioning SRS that are linked.

For semi-persistent positioning SRS with bandwidth aggregation, when the linkage is SRS resource level, and when more than one SRS resource sets are activated, all the SRS resources within the one or more SRS resources are activated for positioning SRS transmission with bandwidth aggregation. In addition, UE only needs to enable SRS bandwidth aggregation for positioning SRS that are linked.

For aperiodic positioning SRS with bandwidth aggregation, when the linkage is SRS resource level, and when more than one SRS resource sets are triggered, all the SRS resources within the one or more SRS resources are triggered for positioning SRS transmission with bandwidth aggregation. In addition, UE may only need to enable SRS bandwidth aggregation for positioning SRS that are linked.

Transmit Power Calculation for Positioning SRS Transmission with Bandwidth Aggregation

Embodiments of transmit power calculation for positioning SRS transmission with bandwidth aggregation are provided as follows:

In one embodiment, when total transmit power for SRS transmission across intra-band contiguous carriers exceeds maximum transmit power that is configured for a UE, the UE may apply a power backoff on the positioning SRS transmission in each carrier, where the power backoff may depend on the transmission bandwidth for positioning SRS in different carriers.

In one example, when only simultaneous SRS across intra-band contiguous carriers are transmitted in a symbol in a slot, the total transmit power backoff a (in linear value) can be given by

$$α = {\sum }_{c = 0}^{C - 1} {\hat{P}}_{SRS , b , f , c} ( i , {q}_{s} ) - {\hat{P}}_{CMAX , f , c} ( i )$$

Where P_{SRS,b,f,c}(i, qₛ) is SRS transmission power in SRS transmission occasion i on active UL BWP b of carrier f of serving cell c; P_{CMAX,f,c}(i) is the UE configured maximum output power defined in [8, TS 38.101-1], [8-2, TS 38.101-2] and [TS 38.101-3] for carrier f of serving cell c in SRS transmission occasion i; and P_{SRS,b,f,c}(i, qₛ) and P_{CMAx,f,c}(i) are the linear values of P_{SRS,b,f,c}(i, qₛ) and P_{CMAX,f,c}(i), respectively. C is the number of carriers for positioning SRS with bandwidth aggregation.

In this case, the transmit power backoff for SRS transmission in each carrier (in linear value) can be determined as

$${α}_{SRS , b , f , c} ( i ) = α \cdot \frac{{M}_{SRS , b , f , c} ( i )}{{\sum }_{c = 0}^{C - 1} {M}_{SRS , b , f , c} ( i )} = \frac{{M}_{SRS , b , f , c} ( i )}{{\sum }_{c = 0}^{C - 1} {M}_{S RS , b , f , c} ( i )} ( {\sum }_{c = 0}^{C - 1} {\hat{P}}_{SRS , b , f , c} ( i , {q}_{s} ) - {\hat{P}}_{CMAX , f , c} ( i ) )$$

Then, the transmit power (in dBm) for positioning SRS in SRS transmission occasion i on active UL BWP b of carrier f of serving cell c can be given by

$${P}_{SRS , b , f , c} ( i , {q}_{s} ) - 10 {log}_{10} ( {α}_{SRS , b , f , c} ( i ) )$$

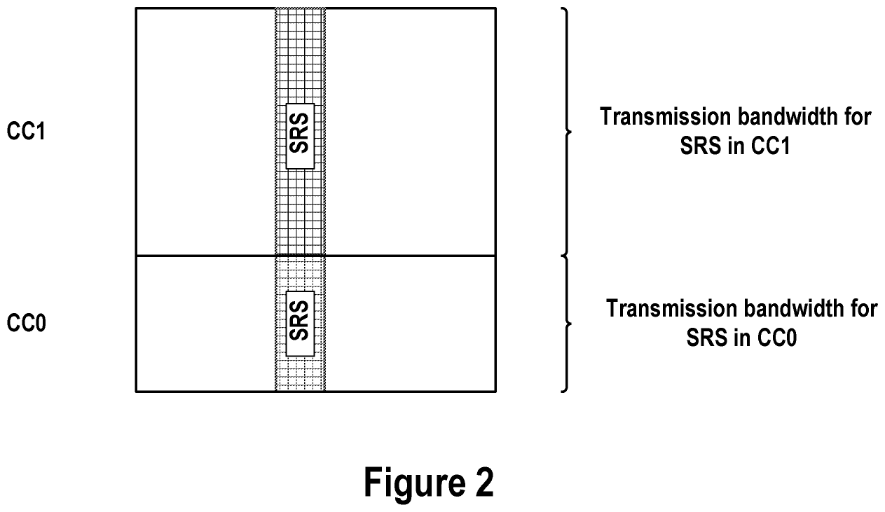

FIG. 2 illustrates an example of transmit power determination for positioning SRS with bandwidth aggregation. In the example, the total transmit power of SRS transmission in different carriers exceeds the maximum transmit power. In this case, the transmit power backoff for positioning SRS in each carrier can be determined based on the total transmission bandwidth of the SRS and transmission bandwidth in each carrier.

In one embodiment, if the UE is in the RRC_CONNECTED state and determines that the UE is not able to accurately measure PL_{b,f,c}(q_{d}), or the UE is not provided with pathlossReferenceRS-Pos, the UE calculates PL_{b,f,c}(q_{d}) using a RS resource obtained from the SS/PBCH block of the serving cell that the UE uses to obtain MIB. In this case, for positioning SRS with bandwidth aggregation, pathloss or transmit power of positioning SRS in other carriers can be determined using a RS resource obtained from the SS/PBCH block of the serving cell that the UE uses to obtain MIB.

In one embodiment, if the UE is in the RRC_INACTIVE state and determines that the UE is not able to accurately measure PL_{b,f,c}(q_{d}), the UE does not transmit SRS for the SRS resource set. In this case, UE may not transmit the positioning SRS in other carriers in case of positioning SRS with bandwidth aggregation.

Measurement Report for PRS and Positioning SRS with Bandwidth Aggregation

Embodiment of measurement report for PRS and positioning SRS with bandwidth aggregation are provided as follows:

In one embodiment, when PRS is cancelled or dropped in one or more of the carriers across intra-band contiguous carriers, UE may report to a location management function (LMF) via LTE Positioning Protocol (LPP) one or more carrier index(es) in the measurement report where UE measures the PRS.

In an embodiment, when SRS is cancelled or dropped in one or more of the carriers across intra-band contiguous carriers, gNB may report to a location management function (LMF) via NR Positioning Protocol (NRPPa) one or more carrier index(es) in the measurement report where gNB measures the SRS.

### Systems and Implementations

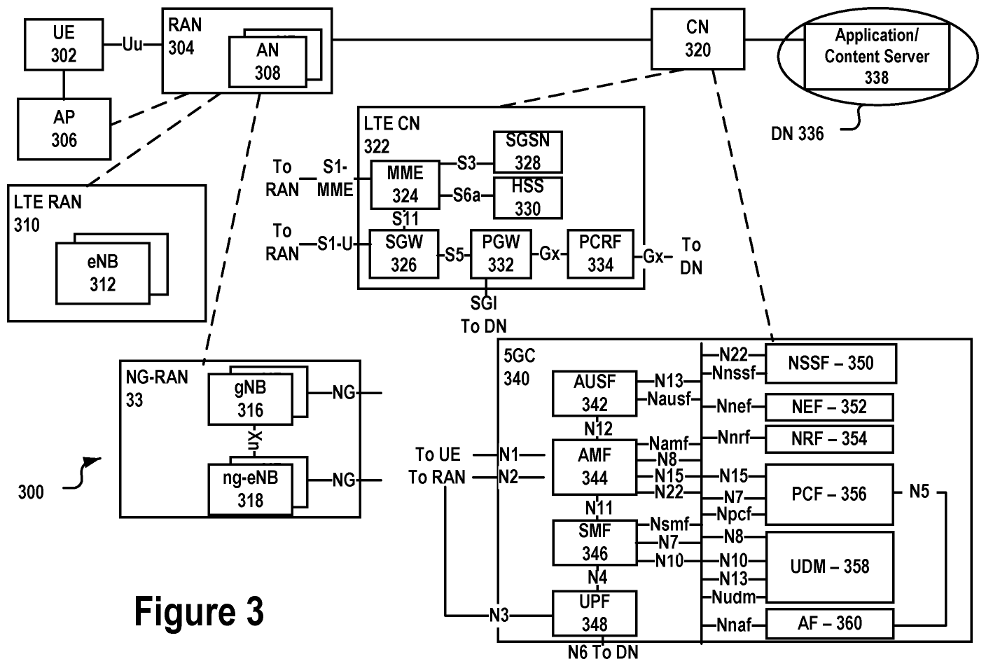

FIGS. 3-6 illustrate various systems, devices, and components that may implement aspects of disclosed embodiments.

FIG. 3 illustrates a network 300 in accordance with various embodiments. The network 300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 300 may include a UE 302, which may include any mobile or non-mobile computing device designed to communicate with a RAN 304 via an over-the-air connection. The UE 302 may be communicatively coupled with the RAN 304 by a Uu interface. The UE 302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 302 may additionally communicate with an AP 306 via an over-the-air connection. The AP 306 may manage a WLAN connection, which may serve to offload some/all network traffic from the RAN 304. The connection between the UE 302 and the AP 306 may be consistent with any IEEE 802.11 protocol, wherein the AP 306 could be a wireless fidelity (Wi-Fi®) router. In some embodiments, the UE 302, RAN 304, and AP 306 may utilize cellular-WLAN aggregation (for example, LWA/LWIP). Cellular-WLAN aggregation may involve the UE 302 being configured by the RAN 304 to utilize both cellular radio resources and WLAN resources.

The RAN 304 may include one or more access nodes, for example, AN 308. AN 308 may terminate air-interface protocols for the UE 302 by providing access stratum protocols including RRC, PDCP, RLC, MAC, and L1 protocols. In this manner, the AN 308 may enable data/voice connectivity between CN 320 and the UE 302. In some embodiments, the AN 308 may be implemented in a discrete device or as one or more software entities running on server computers as part of, for example, a virtual network, which may be referred to as a CRAN or virtual baseband unit pool. The AN 308 be referred to as a BS, gNB, RAN node, eNB, ng-eNB, NodeB, RSU, TRxP, TRP, etc. The AN 308 may be a macrocell base station or a low power base station for providing femtocells, picocells or other like cells having smaller coverage areas, smaller user capacity, or higher bandwidth compared to macrocells.

In embodiments in which the RAN 304 includes a plurality of ANs, they may be coupled with one another via an X2 interface (if the RAN 304 is an LTE RAN) or an Xn interface (if the RAN 304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 304 may each manage one or more cells, cell groups, component carriers, etc. to provide the UE 302 with an air interface for network access. The UE 302 may be simultaneously connected with a plurality of cells provided by the same or different ANs of the RAN 304. For example, the UE 302 and RAN 304 may use carrier aggregation to allow the UE 302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 302 or AN 308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 304 may be an LTE RAN 310 with eNBs, for example, eNB 312. The LTE RAN 310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 304 may be an NG-RAN 314 with gNBs, for example, gNB 316, or ng-eNBs, for example, ng-eNB 318. The gNB 316 may connect with 5G-enabled UEs using a 5G NR interface. The gNB 316 may connect with a 5G core through an NG interface, which may include an N2 interface or an N3 interface. The ng-eNB 318 may also connect with the 5G core through an NG interface, but may connect with a UE via an LTE air interface. The gNB 316 and the ng-eNB 318 may connect with each other over an Xn interface.

In some embodiments, the NG interface may be split into two parts, an NG user plane (NG-U) interface, which carries traffic data between the nodes of the NG-RAN 314 and a UPF 348 (e.g., N3 interface), and an NG control plane (NG-C) interface, which is a signaling interface between the nodes of the NG-RAN314 and an AMF 344 (e.g., N2 interface).

The NG-RAN 314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 302 can be configured with multiple BWPs where each BWP configuration has a different SCS. When a BWP change is indicated to the UE 302, the SCS of the transmission is changed as well. Another use case example of BWP is related to power saving. In particular, multiple BWPs can be configured for the UE 302 with different amount of frequency resources (for example, PRBs) to support data transmission under different traffic loading scenarios. A BWP containing a smaller number of PRBs can be used for data transmission with small traffic load while allowing power saving at the UE 302 and in some cases at the gNB 316. A BWP containing a larger number of PRBs can be used for scenarios with higher traffic load.

The RAN 304 is communicatively coupled to CN 320 that includes network elements to provide various functions to support data and telecommunications services to customers/subscribers (for example, users of UE 302). The components of the CN 320 may be implemented in one physical node or separate physical nodes. In some embodiments, NFV may be utilized to virtualize any or all of the functions provided by the network elements of the CN 320 onto physical compute/storage resources in servers, switches, etc. A logical instantiation of the CN 320 may be referred to as a network slice, and a logical instantiation of a portion of the CN 320 may be referred to as a network sub-slice.

In some embodiments, the CN 320 may be an LTE CN 322, which may also be referred to as an EPC. The LTE CN 322 may include MME 324, SGW 326, SGSN 328, HSS 330, PGW 332, and PCRF 334 coupled with one another over interfaces (or “reference points”) as shown. Functions of the elements of the LTE CN 322 may be briefly introduced as follows.

The MME 324 may implement mobility management functions to track a current location of the UE 302 to facilitate paging, bearer activation/deactivation, handovers, gateway selection, authentication, etc.

The SGW 326 may terminate an S1 interface toward the RAN and route data packets between the RAN and the LTE CN 322. The SGW 326 may be a local mobility anchor point for inter-RAN node handovers and also may provide an anchor for inter-3GPP mobility. Other responsibilities may include lawful intercept, charging, and some policy enforcement.

The SGSN 328 may track a location of the UE 302 and perform security functions and access control. In addition, the SGSN 328 may perform inter-EPC node signaling for mobility between different RAT networks; PDN and S-GW selection as specified by MME 324; MME selection for handovers; etc. The S3 reference point between the MME 324 and the SGSN 328 may enable user and bearer information exchange for inter-3GPP access network mobility in idle/active states.

The HSS 330 may include a database for network users, including subscription-related information to support the network entities' handling of communication sessions. The HSS 330 can provide support for routing/roaming, authentication, authorization, naming/addressing resolution, location dependencies, etc. An S6a reference point between the HSS 330 and the MME 324 may enable transfer of subscription and authentication data for authenticating/authorizing user access to the LTE CN 320.

The PGW 332 may terminate an SGi interface toward a data network (DN) 336 that may include an application/content server 338. The PGW 332 may route data packets between the LTE CN 322 and the data network 336. The PGW 332 may be coupled with the SGW 326 by an S5 reference point to facilitate user plane tunneling and tunnel management. The PGW 332 may further include a node for policy enforcement and charging data collection (for example, PCEF). Additionally, the SGi reference point between the PGW 332 and the data network 3 36 may be an operator external public, a private PDN, or an intra-operator packet data network, for example, for provision of IMS services. The PGW 332 may be coupled with a PCRF 334 via a Gx reference point.

The PCRF 334 is the policy and charging control element of the LTE CN 322. The PCRF 334 may be communicatively coupled to the app/content server 338 to determine appropriate QoS and charging parameters for service flows. The PCRF 332 may provision associated rules into a PCEF (via Gx reference point) with appropriate TFT and QCI.

In some embodiments, the CN 320 may be a 5GC 340. The 5GC 340 may include an AUSF 342, AMF 344, SMF 346, UPF 348, NSSF 350, NEF 352, NRF 354, PCF 356, UDM 358, and AF 360 coupled with one another over interfaces (or “reference points”) as shown. Functions of the elements of the 5GC 340 may be briefly introduced as follows.

The AUSF 342 may store data for authentication of UE 302 and handle authentication-related functionality. The AUSF 342 may facilitate a common authentication framework for various access types. In addition to communicating with other elements of the 5GC 340 over reference points as shown, the AUSF 342 may exhibit an Nausf service-based interface.

The AMF 344 may allow other functions of the 5GC 340 to communicate with the UE 302 and the RAN 304 and to subscribe to notifications about mobility events with respect to the UE 302. The AMF 344 may be responsible for registration management (for example, for registering UE 302), connection management, reachability management, mobility management, lawful interception of AMF-related events, and access authentication and authorization. The AMF 344 may provide transport for SM messages between the UE 302 and the SMF 346, and act as a transparent proxy for routing SM messages. AMF 344 may also provide transport for SMS messages between UE 302 and an SMSF. AMF 344 may interact with the AUSF 342 and the UE 302 to perform various security anchor and context management functions. Furthermore, AMF 344 may be a termination point of a RAN CP interface, which may include or be an N2 reference point between the RAN 304 and the AMF 344; and the AMF 344 may be a termination point of NAS (N1) signaling, and perform NAS ciphering and integrity protection. AMF 344 may also support NAS signaling with the UE 302 over an N3 IWF interface.

The SMF 346 may be responsible for SM (for example, session establishment, tunnel management between UPF 348 and AN 308); UE IP address allocation and management (including optional authorization); selection and control of UP function; configuring traffic steering at UPF 348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 344 over N2 to AN 308; and determining SSC mode of a session. SM may refer to management of a PDU session, and a PDU session or “session” may refer to a PDU connectivity service that provides or enables the exchange of PDUs between the UE 302 and the data network 336.

The UPF 348 may act as an anchor point for intra-RAT and inter-RAT mobility, an external PDU session point of interconnect to data network 336, and a branching point to support multi-homed PDU session. The UPF 348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 348 may include an uplink classifier to support routing traffic flows to a data network.

The NSSF 350 may select a set of network slice instances serving the UE 302. The NSSF 350 may also determine allowed NSSAI and the mapping to the subscribed S-NSSAIs, if needed. The NSSF 350 may also determine the AMF set to be used to serve the UE 302, or a list of candidate AMFs based on a suitable configuration and possibly by querying the NRF 354. The selection of a set of network slice instances for the UE 302 may be triggered by the AMF 344 with which the UE 302 is registered by interacting with the NSSF 350, which may lead to a change of AMF. The NSSF 350 may interact with the AMF 344 via an N22 reference point; and may communicate with another NSSF in a visited network via an N31 reference point (not shown). Additionally, the NSSF 350 may exhibit an Nnssf service-based interface.

The NEF 352 may securely expose services and capabilities provided by 3GPP network functions for third party, internal exposure/re-exposure, AFs (e.g., AF 360), edge computing or fog computing systems, etc. In such embodiments, the NEF 352 may authenticate, authorize, or throttle the AFs. NEF 352 may also translate information exchanged with the AF 360 and information exchanged with internal network functions. For example, the NEF 352 may translate between an AF-Service-Identifier and an internal 5GC information. NEF 352 may also receive information from other NFs based on exposed capabilities of other NFs. This information may be stored at the NEF 352 as structured data, or at a data storage NF using standardized interfaces. The stored information can then be re-exposed by the NEF 352 to other NFs and AFs, or used for other purposes such as analytics. Additionally, the NEF 352 may exhibit an Nnef service-based interface.

The NRF 354 may support service discovery functions, receive NF discovery requests from NF instances, and provide the information of the discovered NF instances to the NF instances. NRF 354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 354 may exhibit the Nnrf service-based interface.

The PCF 356 may provide policy rules to control plane functions to enforce them, and may also support unified policy framework to govern network behavior. The PCF 356 may also implement a front end to access subscription information relevant for policy decisions in a UDR of the UDM 358. In addition to communicating with functions over reference points as shown, the PCF 356 exhibit an Npcf service-based interface.

The UDM 358 may handle subscription-related information to support the network entities' handling of communication sessions, and may store subscription data of UE 302. For example, subscription data may be communicated via an N8 reference point between the UDM 358 and the AMF 344. The UDM 358 may include two parts, an application front end and a UDR. The UDR may store subscription data and policy data for the UDM 358 and the PCF 356, and/or structured data for exposure and application data (including PFDs for application detection, application request information for multiple UEs 302) for the NEF 352. The Nudr service-based interface may be exhibited by the UDR 221 to allow the UDM 358, PCF 356, and NEF 352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 358 may exhibit the Nudm service-based interface.

The AF 360 may provide application influence on traffic routing, provide access to NEF, and interact with the policy framework for policy control.

In some embodiments, the 5GC 340 may enable edge computing by selecting operator/3rd party services to be geographically close to a point that the UE 302 is attached to the network. This may reduce latency and load on the network. To provide edge-computing implementations, the 5GC 340 may select a UPF 348 close to the UE 302 and execute traffic steering from the UPF 348 to data network 336 via the N6 interface. This may be based on the UE subscription data, UE location, and information provided by the AF 360. In this way, the AF 360 may influence UPF (re)selection and traffic routing. Based on operator deployment, when AF 360 is considered to be a trusted entity, the network operator may permit AF 360 to interact directly with relevant NFs. Additionally, the AF 360 may exhibit an Naf service-based interface.

The data network 336 may represent various network operator services, Internet access, or third party services that may be provided by one or more servers including, for example, application/content server 338.

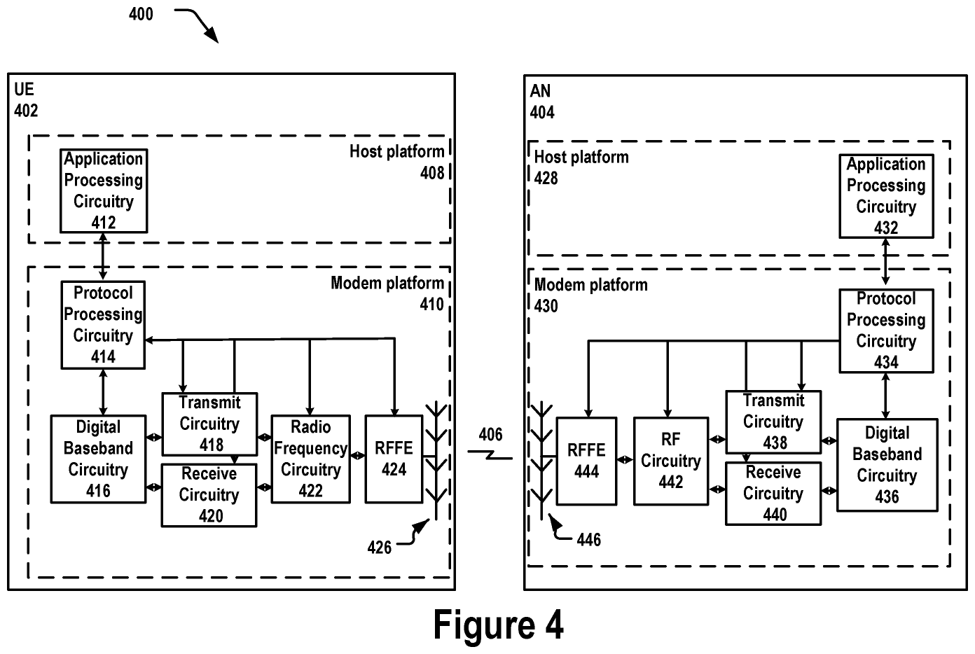

FIG. 4 schematically illustrates a wireless network 400 in accordance with various embodiments. The wireless network 400 may include a UE 402 in wireless communication with an AN 404. The UE 402 and AN 404 may be similar to, and substantially interchangeable with, like-named components described elsewhere herein.

The UE 402 may be communicatively coupled with the AN 404 via connection 406. The connection 406 is illustrated as an air interface to enable communicative coupling, and can be consistent with cellular communications protocols such as an LTE protocol or a 5G NR protocol operating at mmWave or sub-6 GHz frequencies.

The UE 402 may include a host platform 408 coupled with a modem platform 410. The host platform 408 may include application processing circuitry 412, which may be coupled with protocol processing circuitry 414 of the modem platform 410. The application processing circuitry 412 may run various applications for the UE 402 that source/sink application data. The application processing circuitry 412 may further implement one or more layer operations to transmit/receive application data to/from a data network. These layer operations may include transport (for example UDP) and Internet (for example, IP) operations

The protocol processing circuitry 414 may implement one or more of layer operations to facilitate transmission or reception of data over the connection 406. The layer operations implemented by the protocol processing circuitry 414 may include, for example, MAC, RLC, PDCP, RRC and NAS operations.

The modem platform 410 may further include digital baseband circuitry 416 that may implement one or more layer operations that are “below” layer operations performed by the protocol processing circuitry 414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 410 may further include transmit circuitry 418, receive circuitry 420, RF circuitry 422, and RF front end (RFFE) 424, which may include or connect to one or more antenna panels 426. Briefly, the transmit circuitry 418 may include a digital-to-analog converter, mixer, intermediate frequency (IF) components, etc.; the receive circuitry 420 may include an analog-to-digital converter, mixer, IF components, etc.; the RF circuitry 422 may include a low-noise amplifier, a power amplifier, power tracking components, etc.; RFFE 424 may include filters (for example, surface/bulk acoustic wave filters), switches, antenna tuners, beamforming components (for example, phase-array antenna components), etc. The selection and arrangement of the components of the transmit circuitry 418, receive circuitry 420, RF circuitry 422, RFFE 424, and antenna panels 426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 414 may include one or more instances of control circuitry (not shown) to provide control functions for the transmit/receive components.

A UE reception may be established by and via the antenna panels 426, RFFE 424, RF circuitry 422, receive circuitry 420, digital baseband circuitry 416, and protocol processing circuitry 414. In some embodiments, the antenna panels 426 may receive a transmission from the AN 404 by receive-beamforming signals received by a plurality of antennas/antenna elements of the one or more antenna panels 426.

A UE transmission may be established by and via the protocol processing circuitry 414, digital baseband circuitry 416, transmit circuitry 418, RF circuitry 422, RFFE 424, and antenna panels 426. In some embodiments, the transmit components of the UE 404 may apply a spatial filter to the data to be transmitted to form a transmit beam emitted by the antenna elements of the antenna panels 426.

Similar to the UE 402, the AN 404 may include a host platform 428 coupled with a modem platform 430. The host platform 428 may include application processing circuitry 432 coupled with protocol processing circuitry 434 of the modem platform 430. The modem platform may further include digital baseband circuitry 436, transmit circuitry 438, receive circuitry 440, RF circuitry 442, RFFE circuitry 444, and antenna panels 446. The components of the AN 404 may be similar to and substantially interchangeable with like-named components of the UE 402. In addition to performing data transmission/reception as described above, the components of the AN 408 may perform various logical functions that include, for example, RNC functions such as radio bearer management, uplink and downlink dynamic radio resource management, and data packet scheduling.

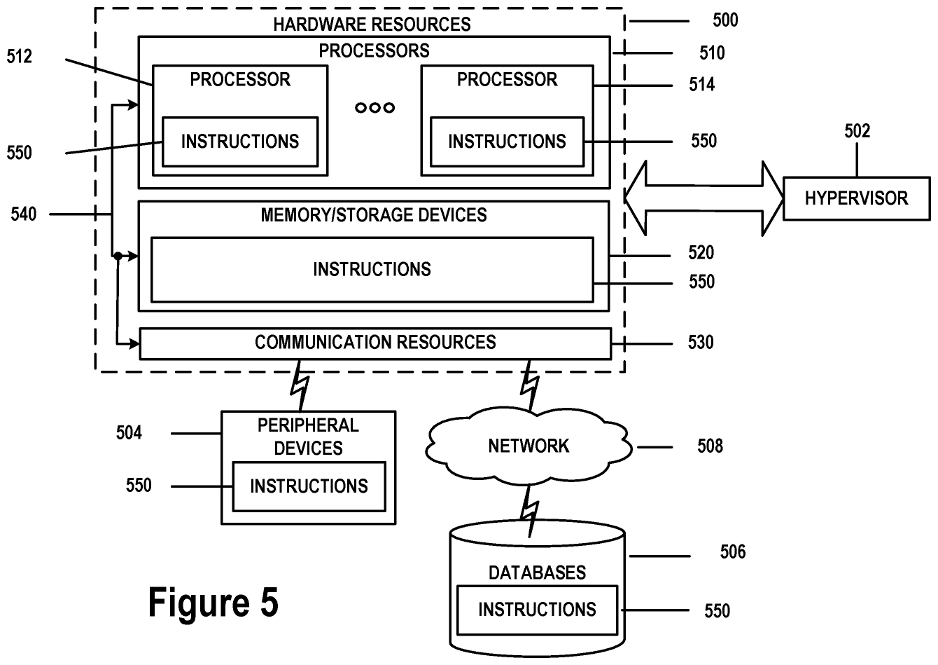

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540 or other interface circuitry. For embodiments where node virtualization (e.g., NFV) is utilized, a hypervisor 502 may be executed to provide an execution environment for one or more network slices/sub-slices to utilize the hardware resources 500.

The processors 510 may include, for example, a processor 512 and a processor 514. The processors 510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 520 may include main memory, disk storage, or any suitable combination thereof. The memory/storage devices 520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 530 may include interconnection or network interface controllers, components, or other suitable devices to communicate with one or more peripheral devices 504 or one or more databases 506 or other network elements via a network 508. For example, the communication resources 530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

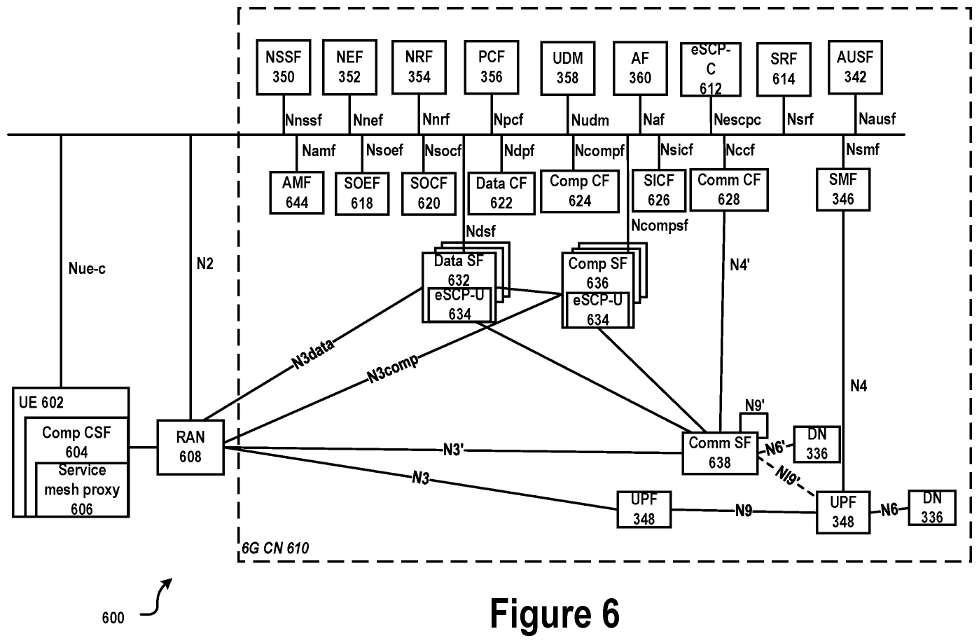

FIG. 6 illustrates a network 600 in accordance with various embodiments. The network 600 may operate in a matter consistent with 3GPP technical specifications or technical reports for 6G systems. In some embodiments, the network 600 may operate concurrently with network 300. For example, in some embodiments, the network 600 may share one or more frequency or bandwidth resources with network 300. As one specific example, a UE (e.g., UE 602) may be configured to operate in both network 600 and network 300. Such configuration may be based on a UE including circuitry configured for communication with frequency and bandwidth resources of both networks 300 and 600. In general, several elements of network 600 may share one or more characteristics with elements of network 300. For the sake of brevity and clarity, such elements may not be repeated in the description of network 600.

The network 600 may include a UE 602, which may include any mobile or non-mobile computing device designed to communicate with a RAN 608 via an over-the-air connection. The UE 602 may be similar to, for example, UE 302. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 6, in some embodiments the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 6, the UE 602 may be communicatively coupled with an AP such as AP 306 as described with respect to FIG. 3. Additionally, although not specifically shown in FIG. 6, in some embodiments the RAN 608 may include one or more ANss such as AN 308 as described with respect to FIG. 3. The RAN 608 and/or the AN of the RAN 608 may be referred to as a base station (BS), a RAN node, or using some other term or name.

The UE 602 and the RAN 608 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 608 may allow for communication between the UE 602 and a 6G core network (CN) 610. Specifically, the RAN 608 may facilitate the transmission and reception of data between the UE 602 and the 6G CN 610. The 6G CN 610 may include various functions such as NSSF 350, NEF 352, NRF 354, PCF 356, UDM 358, AF 360, SMF 346, and AUSF 342. The 6G CN 610 may additional include UPF 348 and DN 336 as shown in FIG. 6.

Additionally, the RAN 608 may include various additional functions that are in addition to, or alternative to, functions of a legacy cellular network such as a 4G or 5G network. Two such functions may include a Compute Control Function (Comp CF) 624 and a Compute Service Function (Comp SF) 636. The Comp CF 624 and the Comp SF 636 may be parts or functions of the Computing Service Plane. Comp CF 624 may be a control plane function that provides functionalities such as management of the Comp SF 636, computing task context generation and management (e.g., create, read, modify, delete), interaction with the underlying computing infrastructure for computing resource management, etc. Comp SF 636 may be a user plane function that serves as the gateway to interface computing service users (such as UE 602) and computing nodes behind a Comp SF instance. Some functionalities of the Comp SF 636 may include: parse computing service data received from users to compute tasks executable by computing nodes; hold service mesh ingress gateway or service API gateway; service and charging policies enforcement; performance monitoring and telemetry collection, etc. In some embodiments, a Comp SF 636 instance may serve as the user plane gateway for a cluster of computing nodes. A Comp CF 624 instance may control one or more Comp SF 636 instances.

Two other such functions may include a Communication Control Function (Comm CF) 628 and a Communication Service Function (Comm SF) 638, which may be parts of the Communication Service Plane. The Comm CF 628 may be the control plane function for managing the Comm SF 638, communication sessions creation/configuration/releasing, and managing communication session context. The Comm SF 638 may be a user plane function for data transport. Comm CF 628 and Comm SF 638 may be considered as upgrades of SMF 346 and UPF 348, which were described with respect to a 5G system in FIG. 3. The upgrades provided by the Comm CF 628 and the Comm SF 638 may enable service-aware transport. For legacy (e.g., 4G or 5G) data transport, SMF 346 and UPF 348 may still be used.

Two other such functions may include a Data Control Function (Data CF) 622 and Data Service Function (Data SF) 632 may be parts of the Data Service Plane. Data CF 622 may be a control plane function and provides functionalities such as Data SF 632 management, Data service creation/configuration/releasing, Data service context management, etc. Data SF 632 may be a user plane function and serve as the gateway between data service users (such as UE 602 and the various functions of the 6G CN 610) and data service endpoints behind the gateway. Specific functionalities may include include: parse data service user data and forward to corresponding data service endpoints, generate charging data, report data service status.

Another such function may be the Service Orchestration and Chaining Function (SOCF) 620, which may discover, orchestrate and chain up communication/computing/data services provided by functions in the network. Upon receiving service requests from users, SOCF 620 may interact with one or more of Comp CF 624, Comm CF 628, and Data CF 622 to identify Comp SF 636, Comm SF 638, and Data SF 632 instances, configure service resources, and generate the service chain, which could contain multiple Comp SF 636, Comm SF 638, and Data SF 632 instances and their associated computing endpoints. Workload processing and data movement may then be conducted within the generated service chain. The SOCF 620 may also responsible for maintaining, updating, and releasing a created service chain.

Another such function may be the service registration function (SRF) 614, which may act as a registry for system services provided in the user plane such as services provided by service endpoints behind Comp SF 636 and Data SF 632 gateways and services provided by the UE 602. The SRF 614 may be considered a counterpart of NRF 354, which may act as the registry for network functions.

Other such functions may include an evolved service communication proxy (eSCP) and service infrastructure control function (SICF) 626, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 612 and eSCP-U 634, for control plane service communication proxy and user plane service communication proxy, respectively. The SICF 626 may control and configure eCSP instances in terms of service traffic routing policies, access rules, load balancing configurations, performance monitoring, etc.

Another such function is the AMF 644. The AMF 644 may be similar to 344, but with additional functionality. Specifically, the AMF 644 may include potential functional repartition, such as move the message forwarding functionality from the AMF 644 to the RAN 608.

Another such function is the service orchestration exposure function (SOEF) 618. The SOEF may be configured to expose service orchestration and chaining services to external users such as applications.

The UE 602 may include an additional function that is referred to as a computing client service function (comp CSF) 604. The comp CSF 604 may have both the control plane functionalities and user plane functionalities, and may interact with corresponding network side functions such as SOCF 620, Comp CF 624, Comp SF 636, Data CF 622, and/or Data SF 632 for service discovery, request/response, compute task workload exchange, etc. The Comp CSF 604 may also work with network side functions to decide on whether a computing task should be run on the UE 602, the RAN 608, and/or an element of the 6G CN 610.

The UE 602 and/or the Comp CSF 604 may include a service mesh proxy 606. The service mesh proxy 606 may act as a proxy for service-to-service communication in the user plane.

Capabilities of the service mesh proxy 606 may include one or more of addressing, security, load balancing, etc.

### Example Procedures

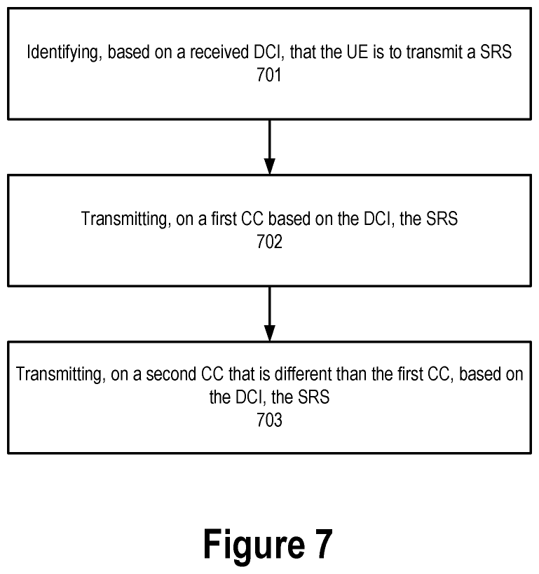

In some embodiments, the electronic device(s), network(s), system(s), chip(s) or component(s), or portions or implementations thereof, of FIGS. 3-6, or some other figure herein, may be configured to perform one or more processes, techniques, or methods as described herein, or portions thereof. One such process is depicted in FIG. 7. The process of FIG. 7 may relate to or include a method to be performed by a user equipment (UE), one or more elements of a UE, and/or one or more electronic devices that include and/or implement a UE. The process may include identifying, at 701 based on a received downlink control information (DCI), that the UE is to transmit a sounding reference signal (SRS); transmitting, at 702 on a first component carrier (CC) based on the DCI, the SRS; and transmitting, at 703 on a second CC that is different than the first CC, based on the DCI, the SRS.

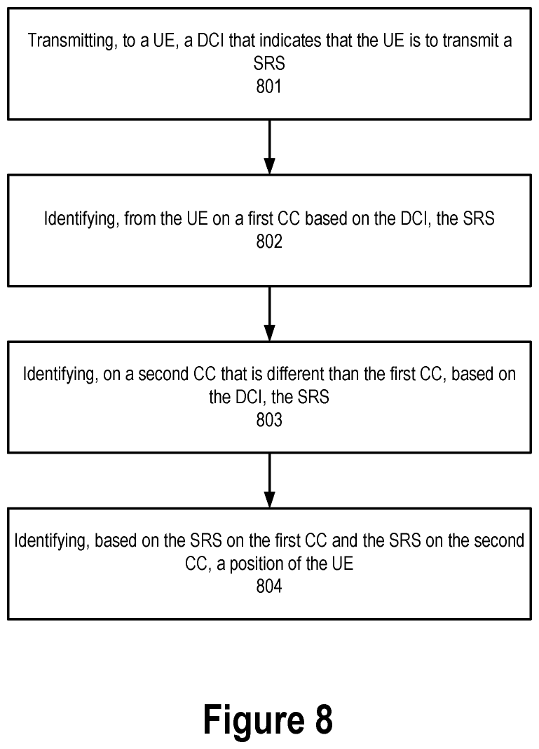

Another such process is depicted in FIG. 8. The process of FIG. 8 may relate to or include a method to be performed by a base station, one or more elements of a base station, and/or one or more electronic devices that include and/or implement a base station. The base station may be, for example, a gNB or some other type of base station. The proceess may include transmitting, at 801 to a user equipment (UE), a downlink control information (DCI) that indicates that the UE is to transmit a sounding reference signal (SRS): identifying, at 802 from the UE on a first component carrier (CC) based on the DCI, the SRS; identifying, at 803 on a second CC that is different than the first CC, based on the DCI, the SRS; and identifying, at 804 based on the SRS on the first CC and the SRS on the second CC, a position of the UE.

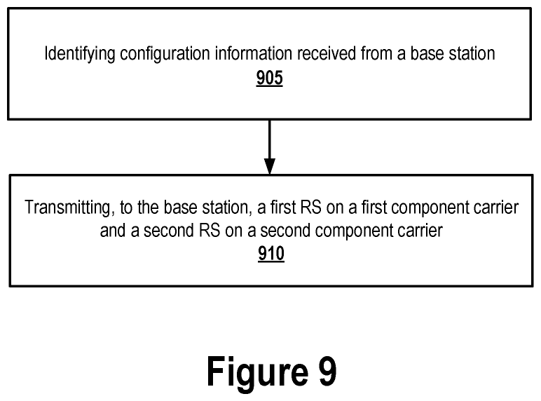

Another such process is depicted in FIG. 9. The process of FIG. 9 may include or relate to a method to be performed by a user equipment (UE), one or more elements of a UE, and/or one or more electronic devices that include and/or implement a UE. The process may include identifying, at 905, configuration information received from a base station. In some embodiments, the configuration information may include one or more of: a resource configuration that indicates that the UE is to transmit a first reference signal (RS) on a first component carrier of a plurality of component carriers, wherein the first RS is an RS of a first RS set; and a resource configuration that indicates that the UE is to transmit a second RS on a second component carrier of the plurality of component carriers, wherein the second RS is an RS of a second RS set, wherein the first RS resource set and the second RS resource set are linked for bandwidth aggregation. The process may further include transmitting, at 910 to the base station, the first RS on the first component carrier and the second RS on the second component carrier.

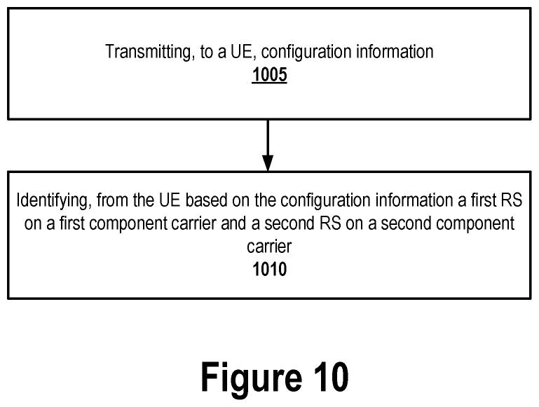

Another such process is depicted in FIG. 10. The process of FIG. 10 may include or relate to a method to be performed by a base station, one or more elements of a base station, and/or one or more electronic devices that include and/or implement a base station. The process may include transmitting, at 1005, configuration information to a user equipment (UE). In some embodiments, the configuration information may include one or more of: a resource configuration that indicates that the UE is to transmit a first reference signal (RS) on a first component carrier of a plurality of component carriers, wherein the first RS is an RS of a first RS set; and a resource configuration that indicates that the UE is to transmit a second RS on a second component carrier of the plurality of component carriers, wherein the second RS is an RS of a second RS set, wherein the first RS resource set and the second RS resource set are linked for bandwidth aggregation. The process may further include identifying, at 1010, the first RS on the first component carrier and the second RS on the second component carrier.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include the system and method of wireless communication for a fifth generation (5G) or new radio (NR) system:

Triggered, by gNodeB, one or more sounding reference signal (SRS) for positioning with bandwidth aggregation in one or more carriers via a downlink control information (DCI) format.

Example 2 may include the method of example 1 or some other example herein, wherein the DC format can be DC format 0_1, 0_2, 0_3 or 1_1, 1_2, 1_3.

Example 3 may include the method of example 1 or some other example herein, wherein one field may be included in the DCI format 0_1, 0_2, 1_1, and 1_2 to indicate one or more positioning SRS resource sets from one or more contiguous carriers for positioning SRS transmission with bandwidth aggregation.

Example 4 may include the method of example 1 or some other example herein, wherein positioning SRS request table may be configured by higher layers via radio resource control (RRC) signalling, where each entry of the table may include SRS request index for an active BWP for each cell in a set of cells for positioning SRS with bandwidth aggregation

Example 5 may include the method of example 1 or some other example herein, wherein a positioning SRS request table may be configured by higher layers via RRC signalling, where each entry of the table may include SRS request index for each cell in a set of cells for positioning SRS with bandwidth aggregation

Example 6 may include the method of example 1 or some other example herein, wherein the field in the DCI may be used to indicate one entry from the SRS request table

Example 7 may include the method of example 1 or some other example herein, wherein the set of cells that can be used for positioning SRS transmission with bandwidth aggregation can be configured by higher layers via RRC signalling

Example 8 may include the method of example 1 or some other example herein, wherein ‘SRS request’ indexes for all the configured cells are placed according to an ascending order of a serving cell index, wherein the value of ‘SRS request’ index may be determined based on the DCI format 01 or 1_1.

Example 9 may include the method of example 1 or some other example herein, wherein SRS request field in the DCI format 0_1, 0_2, 1_1, and 1_2 may be extended to include additional rows for positioning SRS with bandwidth aggregation.

Example 10 may include the method of example 1 or some other example herein, wherein one field may be included in the DCI format 0_1, 0_2, 1_1, and 1_2 to indicate one or more positioning SRS resource sets from one or more contiguous carriers for positioning SRS transmission with bandwidth aggregation.

Example 11 may include the method of example 1 or some other example herein, wherein one or more groups of positioning SRS resource sets and associated carriers or BWPs may be configured by high layers via RRC signalling; wherein the field for positioning SRS request may point to one group of positioning SRS resource sets and associated carriers or BWPs for SRS transmission with bandwidth aggregation

Example 12 may include the method of example 1 or some other example herein, wherein for UEs in RRC_INACTIVE mode, the UEs may be configured or indicated with initial UL BWP in one carrier while configured with SRS for positioning with bandwidth aggregation in different carriers

Example 13 may include the method of example 1 or some other example herein, wherein a bitmap may be configured to indicate whether one or more PRS resource(s) within a linked PRS resource set that is linked to one or more other PRS resource set(s) in different carriers

Example 14 may include the method of example 1 or some other example herein, wherein UE may determine the linked PRS resource(s) based on the bitmap

Example 15 may include the method of example 1 or some other example herein, wherein a bitmap may be configured to indicate whether one or more SRS resource(s) within a linked SRS resource set that is linked to one or more other SRS resource set(s) in different carriers.

Example 16 may include the method of example 1 or some other example herein, wherein UE may determine the linked SRS resource(s) based on the bitmap

Example 17 may include the method of example 1 or some other example herein, wherein for periodic positioning SRS with bandwidth aggregation, when the linkage is SRS resource level, and when more than one SRS resource sets are configured, only the linked SRS resources within the one or more SRS resources are configured for positioning SRS transmission with bandwidth aggregation

Example 18 may include the method of example 1 or some other example herein, wherein for periodic positioning SRS with bandwidth aggregation, when the linkage is SRS resource level, and when more than one SRS resource sets are configured, all the SRS resources within the one or more SRS resources are configured for positioning SRS transmission with bandwidth aggregation

Example 19 may include the method of example 1 or some other example herein, wherein when total transmit power for SRS transmission across intra-band contiguous carriers exceeds maximum transmit power that is configured for a UE, UE may apply a power backoff on the positioning SRS transmission in each carrier, where the power backoff may depend on the transmission bandwidth for positioning SRS in different carriers

Example 20 may include the method of example 1 or some other example herein, wherein when PRS is cancelled or dropped in one or more of the carriers across intra-band contiguous carriers, UE may report to a location management function (LMF) via LTE Positioning Protocol (LPP) one or more carrier index(es) in the measurement report where UE measures the PRS.

Example 21 may include the method of example 1 or some other example herein, wherein when SRS is cancelled or dropped in one or more of the carriers across intra-band contiguous carriers, gNB may report to a location management function (LMF) via NR Positioning Protocol (NRPPa) one or more carrier index(es) in the measurement report where gNB measures the SRS.

Example 22 may include a method to be performed by a user equipment (UE), one or more elements of a UE, and/or one or more electronic devices that include and/or implement a UE, wherein the method comprises:
identifying, based on a received downlink control information (DCI), that the UE is to transmit a sounding reference signal (SRS);
transmitting, on a first component carrier (CC) based on the DCI, the SRS; and
transmitting, on a second CC that is different than the first CC, based on the DCI, the SRS.

Example 23 may include the method of example 22, and/or some other example herein, wherein the SRS on the first CC at least partially overlaps in time the SRS on the second CC.

Example 24 may include the method of any of examples 22-23, and/or some other example herein, wherein the first CC and the second CC are contiguous.

Example 25 may include the method of any of examples 22-24, and/or some other example herein, wherein transmission on the first CC and the second CC is based on one or more index values in the DCI.

Example 26 may include the method of example 25, wherein the index values relate to an index that was signaled to the UE via higher layer signaling.

Example 27 may include the method of any of examples 22-26, and/or some other example herein, wherein a base station is to identify a position of the UE based on the SRS on the first CC and the SRS on the second CC.

Example 28 may include a method to be performed by a base station, one or more elements of a base station, and/or one or more electronic devices that include and/or implement a base station, wherein the method comprises:
transmitting, to a user equipment (UE), a downlink control information (DCI) that indicates that the UE is to transmit a sounding reference signal (SRS):
identifying, from the UE on a first component carrier (CC) based on the DCI, the SRS;
identifying, on a second CC that is different than the first CC, based on the DCI, the SRS; and
identifying, based on the SRS on the first CC and the SRS on the second CC, a position of the UE.

Example 29 may include the method of example 28, and/or some other example herein, wherein the SRS on the first CC at least partially overlaps in time the SRS on the second CC.

Example 30 may include the method of any of examples 28-29, and/or some other example herein, wherein the first CC and the second CC are contiguous.

Example 31 may include the method of any of examples 28-30, and/or some other example herein, wherein transmission on the first CC and the second CC is based on one or more index values in the DCI.

Example 32 may include the method of example 31, wherein the index values relate to an index that was signaled to the UE via higher layer signaling.

Example 33 may include a method to be performed by a user equipment (UE), one or more elements of a UE, and/or one or more electronic devices that include and/or implement a UE, wherein the method comprises: identifying configuration information received from a base station, wherein the configuration information includes: an indication of an uplink (UL) bandwidth part (BWP) configured in a first component carrier of a plurality of component carriers; a resource configuration that indicates that the UE is to transmit a first reference signal (RS) on a second component carrier of the plurality of component carriers, wherein the first RS is an RS of a first RS set; and a resource configuration that indicates that the UE is to transmit a second RS on a third component carrier of the plurality of component carriers, wherein the second RS is an RS of a second RS set; and transmitting, to the base station, the first RS on the second component carrier and the second RS on the third component carrier; wherein the first RS resource set and the second RS resource set are linked for bandwidth aggregation.

Example 34 may include the method of example 33, and/or some other example herein, wherein the configuration information is received when the UE is in an RRC_INACTIVE mode.

Example 35 may include the method of any of examples 33-34, and/or some other example herein, wherein the configuration information is received in a radio resource control (RRC) release message.

Example 36 may include the method of any of examples 33-35, and/or some other example herein, wherein the plurality of component carriers are contiguous component carriers.

Example 37 may include the method of any of examples 33-36, and/or some other example herein, wherein the first RS is a sounding reference signal (SRS).

Example 38 may include the method of any of examples 33-37, and/or some other example herein, wherein the first RS is a positioning reference signal (PRS).

Example 39 may include the method of any of examples 33-37, and/or some other example herein, wherein bandwidth aggregation is related to joint measurement of the first RS and the second RS to generate a measurement of a wideband RS.

Example 40 may include a method to be performed by a base station, one or more elements of a base station, and/or one or more electronic devices that include and/or implement a base station, wherein the method comprises: identifying configuration information to be transmitted to a user equipment (UE), wherein the configuration information includes: an indication of an uplink (UL) bandwidth part (BWP) configured in a first component carrier of a plurality of component carriers; a resource configuration that indicates that the UE is to transmit a first reference signal (RS) on a second component carrier of the plurality of component carriers, wherein the first RS is an RS of a first RS set; and a resource configuration that indicates that the UE is to transmit a second RS on a third component carrier of the plurality of component carriers, wherein the second RS is an RS of a second RS set; transmitting, to the UE, the configuration information; and identifying, from the UE based on the configuration information, the first RS on the second component carrier and the second RS on the third component carrier; wherein the first RS resource set and the second RS resource set are linked for bandwidth aggregation.

Example 41 may include the method of example 40, and/or some other example herein, wherein the configuration information is transmitted to the UE when the UE is in an RRC_INACTIVE mode.

Example 42 may include the method of any of examples 40-41, and/or some other example herein, wherein the configuration information is transmitted to the UE in a radio resource control (RRC) release message.

Example 43 may include the method of any of examples 40-42, and/or some other example herein, wherein the plurality of component carriers are contiguous component carriers.

Example 44 may include the method of any of examples 40-43, and/or some other example herein, wherein the first RS is a sounding reference signal (SRS).

Example 45 may include the method of any of examples 40-44, and/or some other example herein, wherein the first RS is a positioning reference signal (PRS).

Example 46 may include the method of any of examples 40-45, and/or some other example herein, wherein bandwidth aggregation is related to joint measurement of the first RS and the second RS to generate a measurement of a wideband RS.

Example 47 may include a method to be performed by a base station, one or more elements of a base station, and/or one or more electronic devices that include and/or implement a base station, wherein the method comprises transmitting, to a user equipment (UE), configuration information that includes: a resource configuration that indicates that the UE is to transmit a first reference signal (RS) on a first component carrier of a plurality of component carriers, wherein the first RS is an RS of a first RS set; and a resource configuration that indicates that the UE is to transmit a second RS on a second component carrier of the plurality of component carriers, wherein the second RS is an RS of a second RS set, wherein the first RS resource set and the second RS resource set are linked for bandwidth aggregation; and identifying the first RS on the first component carrier and the second RS on the second component carrier.

Example 48 may include the method of example 47, and/or some other example herein, wherein the configuration information is transmitted to the UE based on an identification that the UE is in an RRC_INACTIVE mode.

Example 49 may include the method of any of examples 47-48, and/or some other example herein, wherein the first RS is a sounding reference signal (SRS).

Example 50 may include the method of any of examples 47-49, and/or some other example herein, wherein the configuration information further includes an indication of an uplink (UL) bandwidth part (BWP) configured in a third component carrier of the plurality of component carriers.

Example 51 may include the method of any of examples 47-50, and/or some other example herein, wherein the configuration information is received in a radio resource control (RRC) release message.

Example 52 may include the method of any of examples 47-51, and/or some other example herein, wherein the plurality of component carriers are contiguous component carriers.

Example 53 may include the method of any of examples 47-52, and/or some other example herein, wherein bandwidth aggregation is related to joint measurement of the first RS and the second RS to generate a measurement of a wideband RS.

Example 54 may include a method to be performed by a user equipment (UE), one or more elements of a UE, and/or one or more electronic devices that include and/or implement a UE, wherein the method comprises: identifying configuration information received from a base station, wherein the configuration information includes: a resource configuration that indicates that the UE is to transmit a first reference signal (RS) on a first component carrier of a plurality of component carriers, wherein the first RS is an RS of a first RS set; and a resource configuration that indicates that the UE is to transmit a second RS on a second component carrier of the plurality of component carriers, wherein the second RS is an RS of a second RS set, wherein the first RS resource set and the second RS resource set are linked for bandwidth aggregation; and transmitting, to the base station, the first RS on the first component carrier and the second RS on the second component carrier.

Example 55 may include the method of example 54, and/or some other example herein, wherein the configuration information is received when the UE is in an RRC_INACTIVE mode.

Example 56 may include the method of any of examples 54-55, and/or some other example herein, wherein the first RS is a sounding reference signal (SRS).

Example 57 may include the method of any of examples 54-56, and/or some other example herein, wherein the configuration information further includes an indication of an uplink (UL) bandwidth part (BWP) configured in a third component carrier of the plurality of component carriers.

Example 58 may include the method of any of examples 54-57, and/or some other example herein, wherein the configuration information is received in a radio resource control (RRC) release message.

Example 59 may include the method of any of examples 54-58, and/or some other example herein, wherein bandwidth aggregation is related to joint measurement of the first RS and the second RS to generate a measurement of a wideband RS.

Example 60 may include the method of any of examples 54-59, and/or some other example herein, wherein the plurality of component carriers are contiguous component carriers.

Example Z01 may include an apparatus comprising means to perform one or more elements of a method described in or related to any of examples 1-60, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-60, or any other method or process described herein.

Example Z03 may include an apparatus comprising logic, modules, or circuitry to perform one or more elements of a method described in or related to any of examples 1-60, or any other method or process described herein.

Example Z04 may include a method, technique, or process as described in or related to any of examples 1-60, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-60, or portions thereof.

Example Z06 may include a signal as described in or related to any of examples 1-60, or portions or parts thereof.

Example Z07 may include a datagram, packet, frame, segment, protocol data unit (PDU), or message as described in or related to any of examples 1-60, or portions or parts thereof, or otherwise described in the present disclosure.

Example Z08 may include a signal encoded with data as described in or related to any of examples 1-60, or portions or parts thereof, or otherwise described in the present disclosure.

Example Z09 may include a signal encoded with a datagram, packet, frame, segment, protocol data unit (PDU), or message as described in or related to any of examples 1-60, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-60, or portions thereof.

Example Z11 may include a computer program comprising instructions, wherein execution of the program by a processing element is to cause the processing element to carry out the method, techniques, or process as described in or related to any of examples 1-60, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments. Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| ADRF | Analytics Data Repository Function |
| AF | Application Function |
| AM | Acknowledged Mode |
| AMBR | Aggregate Maximum Bit Rate |
| AMF | Access and Mobility Management Function |
| AN | Access Network |
| AnLF | Analytics Logical Function |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital Expenditure |
| CBD | Candidate Beam Detection |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell- specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management |
| | Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type |
| | Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non- Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWDAF | Network Data Analytics Function |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control |
| | layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | SS/PBCH Block Resource Indicator, Synchronization |
| Block SSBRI | Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, VLAN Virtual LAN, Virtual Local |
| | Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields.

The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descisions tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1. An apparatus for use in a user equipment (UE), wherein the apparatus comprises:
a memory to store configuration information received from a base station, wherein the configuration information includes:
a resource configuration that indicates that the UE is to transmit a first reference signal (RS) on a first component carrier of a plurality of component carriers, wherein the first RS is an RS of a first RS set; and
a resource configuration that indicates that the UE is to transmit a second RS on a second component carrier of the plurality of component carriers, wherein the second RS is an RS of a second RS set, wherein the first RS resource set and the second RS resource set are linked for bandwidth aggregation; and
one or more processors configured to facilitate transmission, to the base station, the first RS on the first component carrier and the second RS on the second component carrier.

2. The apparatus of claim 1, wherein the configuration information is received when the UE is in an RRC_INACTIVE mode.

3. The apparatus of claim 1, wherein the first RS is a sounding reference signal (SRS).

4. The apparatus of claim 1, wherein the configuration information further includes an indication of an uplink (UL) bandwidth part (BWP) configured in a third component carrier of the plurality of component carriers.

5. The apparatus of claim 1, wherein the configuration information is received in a radio resource control (RRC) release message.

6. The apparatus of claim 1, wherein the plurality of component carriers are contiguous component carriers.

7. The apparatus of claim 1, wherein bandwidth aggregation is related to joint measurement of the first RS and the second RS to generate a measurement of a wideband RS.

8. One or more non-transitory computer readable media (NTCRM) comprising instructions that, upon execution of the instructions by one or more processors, are to cause a base station to:
transmit, to a user equipment (UE), configuration information that includes:
a resource configuration that indicates that the UE is to transmit a first reference signal (RS) on a first component carrier of a plurality of component carriers, wherein the first RS is an RS of a first RS set; and
a resource configuration that indicates that the UE is to transmit a second RS on a second component carrier of the plurality of component carriers, wherein the second RS is an RS of a second RS set, wherein the first RS resource set and the second RS resource set are linked for bandwidth aggregation; and
identify the first RS on the first component carrier and the second RS on the second component carrier.

9. The one or more NTCRM of claim 8, wherein the configuration information is transmitted to the UE based on an identification that the UE is in an RRC_INACTIVE mode.

10. The one or more NTCRM of claim 8, wherein the first RS is a sounding reference signal (SRS).

11. The one or more NTCRM of claim 8, wherein the configuration information further includes an indication of an uplink (UL) bandwidth part (BWP) configured in a third component carrier of the plurality of component carriers.

12. The one or more NTCRM of claim 8, wherein the configuration information is received in a radio resource control (RRC) release message.

13. The one or more NTCRM of claim 8, wherein the plurality of component carriers are contiguous component carriers.

14. The one or more NTCRM of claim 8, wherein bandwidth aggregation is related to joint measurement of the first RS and the second RS to generate a measurement of a wideband RS.

15. One or more non-transitory computer-readable media (NTCRM) comprising instructions that, upon execution of the instructions by one or more processors, are to cause a user equipment (UE) to:
identify configuration information received from a base station, wherein the configuration information includes:
a resource configuration that indicates that the UE is to transmit a first reference signal (RS) on a first component carrier of a plurality of component carriers, wherein the first RS is an RS of a first RS set; and
a resource configuration that indicates that the UE is to transmit a second RS on a second component carrier of the plurality of component carriers, wherein the second RS is an RS of a second RS set, wherein the first RS resource set and the second RS resource set are linked for bandwidth aggregation; and
transmit, to the base station, the first RS on the first component carrier and the second RS on the second component carrier.

16. The one or more NTCRM of claim 15, wherein the configuration information is received when the UE is in an RRC_INACTIVE mode.

17. The one or more NTCRM of claim 15, wherein the first RS is a sounding reference signal (SRS).

18. The one or more NTCRM of claim 15, wherein the configuration information further includes an indication of an uplink (UL) bandwidth part (BWP) configured in a third component carrier of the plurality of component carriers.

19. The one or more NTCRM of claim 15, wherein the configuration information is received in a radio resource control (RRC) release message.

20. The one or more NTCRM of claim 15, wherein bandwidth aggregation is related to joint measurement of the first RS and the second RS to generate a measurement of a wideband RS.
